(19) United States
(12) Patent Application Publication
(10) Pub. No.: US 2005/0049754 A1
(43) Pub. Date: Mar. 3, 2005

(54) Power and data configurations for building automation systems

(76) Inventors: Craig Ogawa, Loveland, CO (US); Hugh P. Adamson, Boulder, CO (US)

Correspondence Address: Mark D. Trenner;Trenner Law Firm, LLC, 12081 W. Alameda Pkwy #163, Lakewood, CO, 80228, US

(21) Appl. No.: 10/927,673

(22) Filed: Aug. 27, 2004

Related U.S. Application Data
(60) Provisional application No. 60/499,227, filed on Aug. 29, 2003.

(51) Int. Cl. G05B 15/02

(52) U.S. Cl. 700/275

(57) ABSTRACT

Power and data configurations for building automation systems are described and claimed herein. An exemplary implementation of a building automation system comprises an integral data and power bus and first automation device linked to a second automation device via the integral data and power bus. The first automation device includes a power converter to convert an external AC electrical signal into a DC electrical signal for use by the first and second automation devices. Systems and methods for providing power and isolating device and/or network failures are also disclosed.

### PRIORITY APPLICATION

This application claims priority to co-owned U.S. Provisional Patent Application Ser. No. 60/499,227 for “Apparatus and Methods for Configuring Building Automation Systems” of Ogawa, et al. (Attorney Docket No. CVN.006.PRV), filed Aug. 29, 2003, hereby incorporated herein for all that it discloses.

### TECHNICAL FIELD

The described subject matter relates to building automation, and more particularly to building automation system configuration.

### BACKGROUND

The ability to automatically control one or more functions in a building (e.g., lighting, heating, air conditioning, security systems) is known as building automation. Building automation systems may be used, for example, to automatically operate various lighting schemes in a house. Of course building automation systems may be used to control any of a wide variety of other functions, more or less elaborate than controlling lighting schemes.

Building automation systems typically require power lines to provide electrical power to each of the automation devices. Data lines must also be provided so that the devices may communicate with one another and receive instructions from one or more controllers. However, cabling can be expensive and time-consuming to install. In addition, if an automation device fails, communication with the other devices may also fail, particularly when the automation devices are wired in series. Furthermore, network failures may be difficult or impossible to isolate without having to tear into walls.

### SUMMARY

Implementations of power and data configurations for building automation systems are described herein. In an exemplary implementation, a building automation system is provided comprising an integral data and power bus, and a first automation device linked to a second automation device via the integral data and power bus. The first automation device includes a power converter to convert an external AC electrical signal into a DC electrical signal for use by the first and second automation devices.

In another exemplary implementation, a method to provide electrical power to automation devices in a building automation system is provided. The method may include: receiving an AC electrical signal at an automation device; converting the AC electrical signal to a DC electrical signal; coupling the DC electrical signal to the automation device; and coupling the DC electrical signal to other automation devices in the building automation system.

In yet another exemplary implementation, a method of isolating failures in a building automation system is provided. The method may be implemented to: issue a test signal from a first bridge to an automation device; issue another test signal from a second bridge to the automation device; determine that the automation device is functioning properly if at least one bridge receives a reply from the automation device; and determine that the automation device is not functioning properly if neither bridge receives a reply from the automation device.

### BRIEF DESCRIPTION OF THE DRAWINGS

FIG. 1 is an illustration of an exemplary building automation system as it may be configured to deliver both power and data to the automation devices.

FIG. 2 is an illustration of another exemplary building automation system as it may be configured to deliver both power and data to the automation devices.

FIG. 3 is an illustration of an exemplary cabling configuration for automation devices in a building automation system.

FIGS. 4(a)-(b) are illustrations of an exemplary cable for providing data and power in a building automation system.

FIG. 5 is a high-level schematic diagram of an automation device including circuitry to provide power to a building automation system.

FIG. 6 is a flow chart illustrating exemplary operations which may be implemented to provide power to a building automation system.

FIG. 7 is a flow chart illustrating exemplary operations which may be implemented for fault protection in a building automation system.

### DETAILED DESCRIPTION

Configurations described herein may be implemented to provide electrical power and data to automation devices in building automation systems. By way of example, an automation device such as a lighting controller may include circuitry to convert AC electrical power from one or more power supplies for the lamps into DC electrical power which may be used to power one or more other automation devices in the building automation system. The automation devices may be connected to one another using standard cabling (e.g., Category 5E) for both the electrical power and data signals, thereby reducing the cost of installation and materials. In addition, the automation devices may be connected to one another using network loop configurations connected to other networks in the building automation system via redundant bridging devices such that power and data may be delivered uninterrupted to other automation devices even in the event of a network failure.

Exemplary System

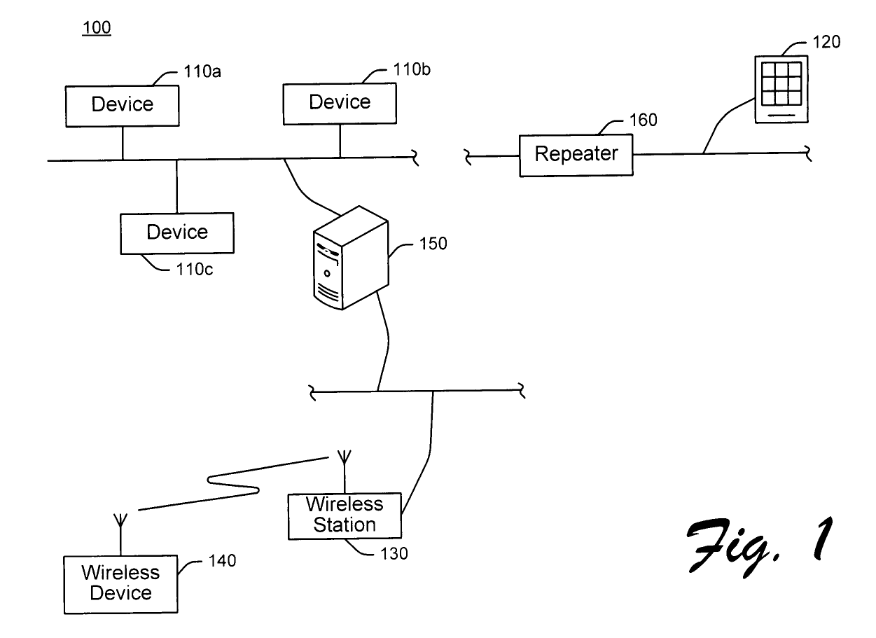

An exemplary building automation system 100 is shown in FIG. 1 as it may be used to automate various functions in a home or other building (e.g., apartment complexes, hotel, offices). By way of example, the building automation system 100 may be used to control lighting, heating, air conditioning, audio/visual distribution, operating window coverings to open/close, and security, to name only a few examples.

Building automation system 100 may include one or more automation devices 110a-c (hereinafter generally referred to as automation devices 110). For purposes of illustration, automation devices 110 may include a keypad 120, wireless station 130, and wireless device 140. In operation a homeowner (or other user) may illuminate artwork hanging on the walls by pressing a key on the keypad 120 which sends a signal to the wireless light controller 140 via the wireless station 130 to lower the central lighting in a room (e.g., to 50% intensity) and raise the perimeter lighting (e.g., to 100% intensity).

It is noted that the automation devices 110 may include any of a wide range of other types and configurations of devices, such as, e.g., security sensors, temperature sensors, light sensors, timers, touch pads, and voice recognition devices, to name only a few.

Building automation system 100 may be implemented using wired and/or wireless networks. Building automation system 100 may also include one or more optional bridges 150 to facilitate network communications between different types of networks (e.g., between a CAN bus and an Ethernet). The term “bridge” refers to both the hardware and software (the entire computer system) and may be implemented as one or more computing systems, such as a server computer.

The bridge 150 may also perform various other services for the building automation system 100. For example, bridge 150 may be implemented as a server computer to process commands for the automation devices 110, provide Internet and email services, broker security, and optionally provide remote access to the building automation system 100.

Building automation network 100 may also include one or more optional repeaters 160, e.g., to extend the physical length of the network, and/or to increase the number of devices that can be provided in the building automation system 100. For example, repeater 160 may be implemented as the physical layer to amplify signals and/or improve the signal to noise ratio of the issued signals in the building automation network 100. Repeater 160 may also be implemented at a higher layer to receive, rebuild, and repeat messages.

It should be noted that the building automation system 100 is not limited to any particular type or configuration. The foregoing example is provided in order to better understand one type of building automation network in which the lighting control systems and methods described herein may be implemented. However, the lighting control systems and methods may also be implemented in other types of building automation systems. The particular configuration may depend in part on design considerations, which can be readily defined and implemented by one having ordinary skill in the art after having become familiar with the teachings of the invention.

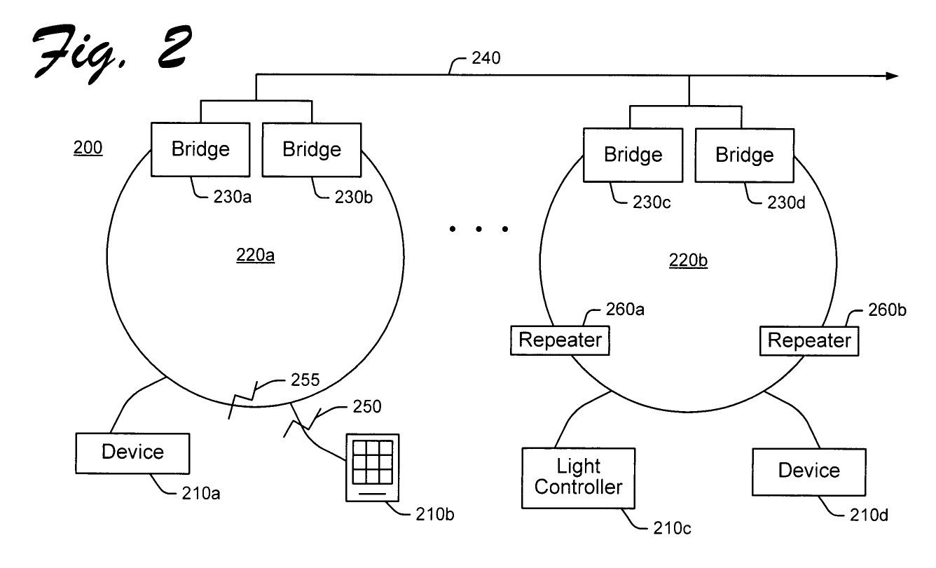

FIG. 2 is an illustration of another exemplary building automation system. Building automation system 200 is shown as it may be implemented to deliver both power and data to automation devices 210a-d such as a keypad and lighting controller (all generally referred to as automation devices 210). The building automation system 200 is also robust so that power and/or data can continue to be delivered to all or some of the automation devices 210 even in the event of a network failure.

The automation devices 210 are operatively associated with one another over a plurality of networks 220a, 220b (generally referred to as 220). In an exemplary implementation the networks 220 are CAN bus “loops” communicatively coupled to one another via one or more bridges 230a-d over an Ethernet network 240. CAN bus loops may also be extended, e.g., using repeaters 260a, 260b. Repeaters 260a, 260b may also be implemented to isolate failures in the network cabling (e.g., cut or damaged cables), and to continue communications with automation devices 210, e.g., on the intact side of each repeater 260a, 260b.

The CAN bus loops may be implemented according to the CAN specification using a two-wire differential serial data bus. The CAN specification is available as versions 1.0 and 2.0 and is published by the International Standards Organization (ISO) as standards 11898 (high-speed) and 11519 (low-speed). The CAN specification defines communication services and protocols for the CAN bus, in particular, the physical layer and the data link layer for communication over the CAN bus. Bus arbitration and error management is also described.

The CAN bus is capable of high-speed data transmission (about 1 Megabits per second (Mbits/s)) over a distance of about 40 meters (m), and can be extended to about 10,000 meters at transmission speeds of about 5 kilobits per second (kbits/s). It is also a robust bus and can be operated in noisy electrical environments while maintaining the integrity of the data.

As briefly discussed above, one or more optional bridges 230 may be used to connect the CAN bus loops to one another via an Ethernet network 240. In an exemplary implementation, redundant bridges 230 may be implemented to identify faults in the CAN bus loops 220. For example, if one of the automation devices 210 or connection from the automation device 210 to the network is shorted or open, it does not disrupt power and/or data communications for the entire CAN bus loop 220. Instead, only the affected automation device(s) are unavailable. The redundant bridge configuration allows communication with each of the other automation devices 210 on the CAN bus loop and with the other bridge to provide fault protection for the building automation system 200.

In an exemplary implementation each of the redundant bridges (e.g., 230a and 230b) on a CAN bus loop (e.g., 220a) is provided with a copy of the operating information for the CAN bus loop 220a. This operating information may include, e.g., device addresses, user preferences, scripts, firmware, etc. to control the automation devices in the CAN bus loop. If one of the bridges fails (e.g., bridge 230a) the other bridge (e.g., 230b) continues to operate the automation devices 210 on the CAN bus loop. Accordingly, the failure is transparent to the building owner.

Bridges 230 may also be operated in a fault diagnostic mode. In an exemplary implementation each bridge (e.g., 230a and 230b) issues signals over the CAN bus loop (e.g., 220a) and receives replies from devices on the CAN bus loop receiving the diagnostic signal from the bridge. If a device fails to reply, the bridge determines whether the automation device 210 has failed or if there is a failure in the network. For example, if neither bridges (e.g., 230a and 230b) received a reply then there may be a failure in the automation device itself or with its connection to the network (e.g., as illustrated at 250). Alternatively, if one of the bridges received a reply but the other bridge did not, then there may be a network failure between the bridge which did not receive a reply and the device(s) which did not reply (e.g., as illustrated at 255). Diagnostics such as those just described may be used, e.g., by a technician, to quickly determine the type of failure and/or location of the failure.

In addition, the redundant bridge configuration may be used to temporarily reroute data around a fault (e.g., 255) in the network 220 so that the failure is transparent to the homeowner (or other user). For purposes of illustration, bridge 230a may issue data to automation device 210a and bridge 230b may issue data automation device 210b.

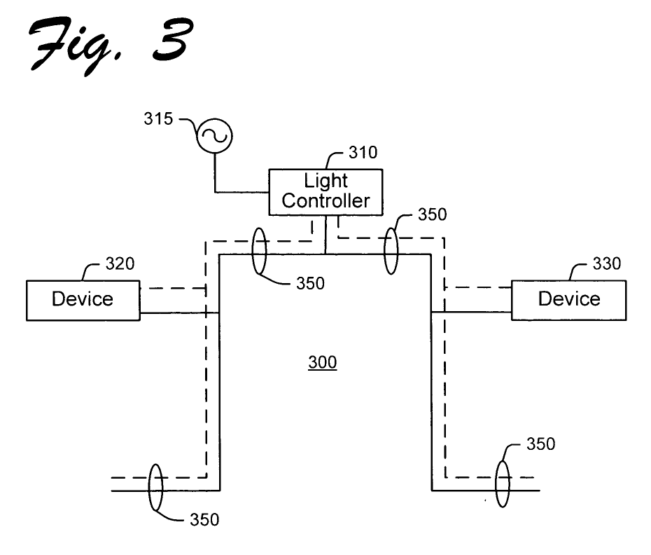

FIG. 3 is an illustration of an exemplary cabling configuration for automation devices in a building automation system 300. In an exemplary implementation, electrical power may be provided by a light controller automation device 310 from a power supply 315 to other automation devices 320, 330 (and optionally to other devices not shown) in the building automation system 300 via cabling 350. It is noted that electrical power may be provided by any automation connected to an electrical power supply and is not limited to light controller automation devices.

Electrical power may be converted, e.g., from an AC power supply for lamps connected to the light controller 310 into DC electrical power. The DC electrical power may be used by the light controller 310 and/or provided to other automation devices 320, 330 via a standard cable such as, e.g., a Category 5E cable or other 22 gauge wire). Such an implementation also allows data signals to be transmitted using the same cabling.

This implementation also allows the devices to be connected by a common power (and ground) and data bus. The power cable is installed simultaneously with the data cable thereby eliminating or at least reducing the need for an electrician for installation and reducing the cost of labor and material. In addition, each leg is wired in parallel as shown in FIG. 3. Accordingly, power may still be provided to the other devices if one leg is broken.

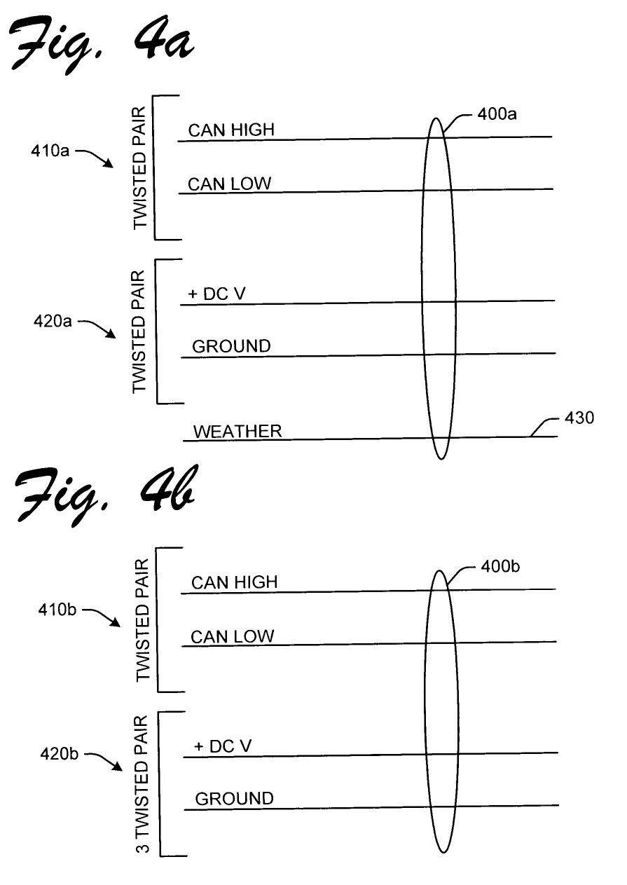

FIGS. 4(a)-(b) are illustrations of an exemplary cable 400a, 400b for providing data and power in a building automation system. In an exemplary implementation a first twisted pair of wires 410a, 410b in the Category 5E cable may be used to provide DC electrical power. Other twisted pair(s) of wires 420a, 420b in the same Category 5E cable may be used to provide data over the network (e.g., CAN bus signals).

Additional lines in the Category 5E cable can be used for other purposes. For example, a weather bus 430 is shown in FIG. 4a and may be provided for transmitting data from a weather station to the bridge or other device. Alternatively, lines may remain unused, or may be used to provide additional electrical power as shown in FIG. 4b, e.g., to increase the available current. For example, each pair may readily support 1 amp allowing 3 amps of current to be provided when three twisted pairs of the cable are used.

Similarly, electrical power may also be provided over the Ethernet to other network devices in other parts of the building automation system. Of course, it is understood that other types of cables and/or wiring can be used and the invention is not limited to CAT 5E cable. For example, where more power may be needed (e.g., 35 Watts RMS per channel for audio amplifiers on the Ethernet), a companion 18 gauge pair of wires may be provided for powering these devices.

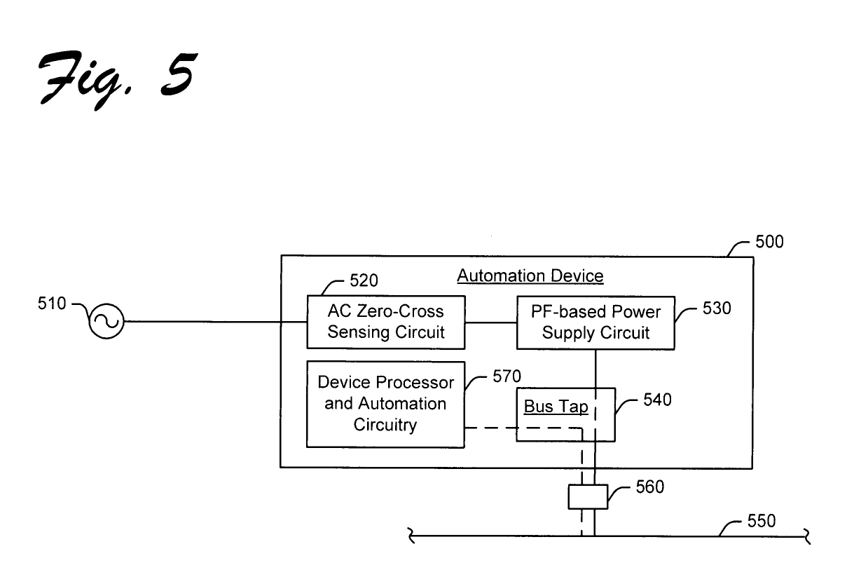

FIG. 5 is a high-level schematic diagram of an automation device 500 including circuitry to provide power to a building automation system. Automation device 500 may be connected to an electrical power source 510, such as, e.g., an AC electrical power source used to power lamps controlled by a light controller automation device.

Automation device 500 may include a zero-cross sensing circuit 520 to detect the position of an alternating current (AC) wave. Zero-cross sensing circuit 520 may be implemented to determine when the current reaches 90 degrees for an inductive load, or when the current is at zero for a resistive load. Zero-cross sensing circuit also provides proper phasing for use with triac controlled devices (e.g., light dimmers) by helping to ensure that the triac(s) turn on at right time.

Automation device 500 may also include a power factor (PF) based power supply circuit 530 to provide a low in-rush current. The PF based power supply circuit 530 may output an isolated 42 volt DC electrical signal. In addition, the PF based power supply circuit 530 allows for power factor correction at low wattage so that power is drawn in phase with the voltage and the AC wave on the power line is not distorted.

Optionally, the PF based power supply circuit 530 may include integral EMI/EMC circuitry, e.g., as regulated by the Federal Communications Commission (FCC) for residential Class B devices to decouple conducted noise and high frequency switching transients from the AC line. Also optionally, a metal oxide varistor (MOV) may be provided to protect against lightening or other transients from being output to other devices in the building automation system.

Automation device 500 may also be provided with a bus tap 540. In an exemplary implementation, bus tap may be connected, e.g., to CAT5E cabling via connector 560 to provide a data and power link with the other automation devices via network 550.

Bus tap 540 may be implemented to couple a high DC signal to other automation devices in the building automation system via network 550. Bus tap 540 may include a buck regulator to convert the 42 volt electrical signal from the PF based power supply circuit 530 into a 5 volt electrical signal for use by the device processor and automation circuitry 570. Bus tap 540 also couples the data signal between the automation device and network 550.

It should be noted that bus tap 540 may also be provided for other automation devices to convert the 42 volt DC signal into a 5 volt DC signal for use by the automation devices and to couple the data signal between the automation device and network 550.

Automation device 500 including power supply circuitry such as described above may be used to power up to 50 automation devices. Alternatively, higher voltage power may be provided for other devices (e.g., an RFID card reader).

The devices may also be provided with protection circuitry so that an installer does not connect the power line to the data line. For example, connectors 560 may be provided which can only be connected to mating connectors on the device motherboard. Accordingly, power supplies for automation device sin the building automation system may be readily installed and removed.

Exemplary Operations

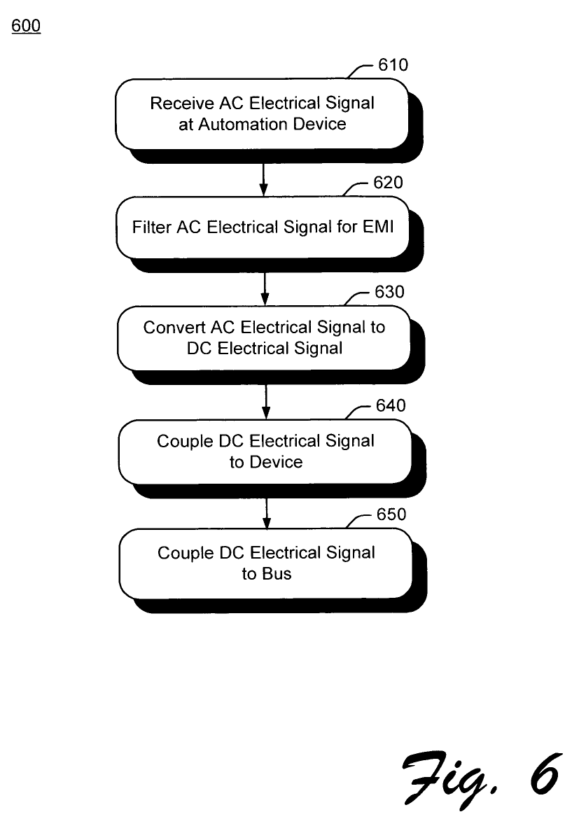

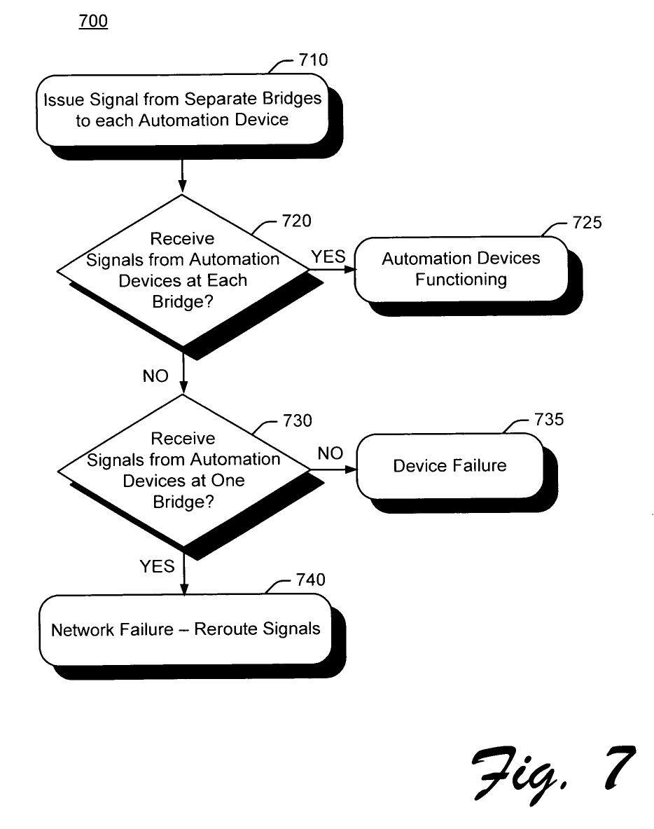

Described herein are exemplary methods for supplying power to a number of building automation devices. The methods described herein may be executed in hardware and/or as computer readable logic instructions. In the exemplary operations shown in FIG. 6, the components and connections depicted in the figures may be used to implement the AC to DC power conversion for use in a building automation system such as those described in more detail above. In the exemplary operations shown in FIG. 7, the components and connections depicted in the figures may be used to implement fault protection and isolate device and/or network failures in a building automation system.

FIG. 6 is a flow chart illustrating exemplary operations 600 which may be implemented to provide power to a building automation system. In operation 610 an AC electrical signal is received at the automation device. For example, where the automation device is a light controller the AC electrical signal may be provided by a power source used to provide electrical power to the lamps controlled by the light controller. In operation 620 the AC electrical signal may be filtered for electromagnetic interference (EMI). In operation 630 the AC electrical signal is converted into a DC electrical signal at the automation device.

In operation 640 the DC electrical signal is coupled to the automation device for use by the automation device itself and/or so it can be provided to one or more other automation devices in the building automation system. If the DC electrical signal is to be provided to other automation devices, it is coupled to the power bus in operation 650 (e.g., for distribution over CAT5E cabling).

FIG. 7 is a flow chart illustrating exemplary operations 700 which may be implemented for fault protection in a building automation system. In operation 710 a plurality of bridges (e.g., redundant bridges) issue signals to each of the automation devices in the building automation system. In operation 720 the bridges receive replies from the automation devices. If the bridges each receive replies from each of the automation devices then the automation devices are functioning properly as illustrated at 725.

If one or more of the bridges do not receive replies from each of the automation devices then the bridges may test to determine whether the fault is a device failure or a network failure. If none of the bridges issuing signals to an automation device received a reply from the automation device then the automation device itself may have failed or is disconnected from the network at 735. If at least one of the bridges did receive a reply from the automation device then the automation device is functioning properly and there is a network failure at 740.

It is noted that in an exemplary implementation the bus bit rate may be slowed to reestablish communication with the automation devices. For example, the bus bit rate may be slowed if both of the CAN data lines (e.g., 410a in FIG. 4) are completely cut because communication at higher bus speeds may be unreliable. Reducing the bit rate allows communication to be reliably reestablished.

The results of these operations may be reported to a technician (or other user) to assist in isolating failures in the building automation system. For example, the results may indicate a network failure between device 1 and device 2, thereby isolating the physical location of the failure for the user or technician. Alternatively, the results may be reported to a central monitoring facility and operation may continue transparent to the user until a technician visit can be scheduled for further testing and/or repairs.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A building automation system comprising:
an integral data and power bus;
a first automation device linked to a second automation device via the integral data and power bus, the first automation device including a power converter to convert an external AC electrical signal into a DC electrical signal for use by the first and second automation devices.

2. The building automation system of claim 1, wherein the integral data and power bus includes a CAN data bus.

3. The building automation system of claim 1, wherein the integral data and power bus is Category 5 cabling connected between the first and second automation devices.

4. The building automation system of claim 1, wherein the integral data and power bus includes electrical power lines connected in parallel between the first and second automation devices.

5. The building automation system of claim 1, wherein the first automation device provides electrical power to a plurality of automation devices.

6. The building automation system of claim 1, wherein the integral data and power bus is configured as a network loop to provide fault protection.

7. The building automation system of claim 1, further comprising redundant bridges for fault protection.

8. The building automation system of claim 1, wherein the first automation device includes a zero cross sensing circuit for providing timing information for the AC electrical signal.

9. The building automation system of claim 1, wherein the first automation device includes a power factor (PF) based power supply circuit for providing a low in-rush current.

10. The building automation system of claim 1, further comprising a bus tap for providing electrical power and data signals from the first automation device onto a building automation network.

11. A method to provide electrical power to automation devices in a building automation system comprising:
receiving an AC electrical signal at an automation device;
converting the AC electrical signal to a DC electrical signal;
coupling the DC electrical signal to the automation device; and
coupling the DC electrical signal to other automation devices in the building automation system.

12. The method of claim 11 further comprising filtering the AC electrical signal for electromagnetic interference (EMI).

13. The method of claim 11 further comprising sensing zero cross of the AC signal.

14. The method of claim 11 further comprising providing phasing of the AC signal.

15. The method of claim 11 further comprising decoupling conducted noise and high frequency switching transients from the AC signal.

16. The method of claim 11 further comprising outputting the DC electrical signal to other automation device over a CAT5E cable.

17. A method for isolating failures in a building automation system comprising:
issuing a test signal from a first bridge to an automation device;
issuing another test signal from a second bridge to the automation device;
determining the automation device is functioning properly if at least one bridge receives a reply from the automation device; and
determining the automation device is not functioning properly if neither bridge receives a reply from the automation device.

18. The method of claim 17, further comprising identifying the physical location of a network failure if only one bridge receives a reply from the automation device.

19. The method of claim 17, further comprising rerouting data signals to the automation device if there is a network failure.

20. The method of claim 17, further comprising reporting a failure to a user.
